(19) United States
(12) Patent Application Publication
(10) Pub. No.: US 2006/0100893 A1
(43) Pub. Date: May 11, 2006

(54) System and method for managing imaged freight documents

(76) Inventors: Jorlaine S. Cunningham, Corona Del Mar, CA (US); James E. Turner, Aliso Viejo, CA (US)

Correspondence Address: JOHN P. O'BANION;O'BANION & RITCHEY LLP, 400 CAPITOL MALL SUITE 1550, SACRAMENTO, CA, 95814, US

(21) Appl. No.: 11/255,098

(22) Filed: Oct. 19, 2005

Related U.S. Application Data
(63) Continuation-in-part of application No. PCT/US04/12301, filed on Apr. 21, 2004.
(60) Provisional application No. 60/464,577, filed on Apr. 21, 2003.

(30) Foreign Application Priority Data
Nov. 4, 2004 (WO) 2004/095195 A2

(51) Int. Cl. G06Q 99/00

(52) U.S. Cl. 705/1

(57) ABSTRACT

A system and method for managing imaged documents includes a manager computer with a scanner and a database connected thereto. The manager computer includes a program for managing the imaged documents. Information within one or more predetermined zones within an imaged document is read and compared against a database of reference information so as to record each document as a “Main Document” or an “Attachment.” For freight documents, “Main Documents” are classified as an “Accounting Copy” or a “Delivery Receipt,” and Bill-of-Lading numbers are read and checked for validity; invalid numbers are flagged for manual recording. Optical character recognition or manual entry is used for textual information, or bar code recognition is used to read bar code information in the zones. Batches of documents are prepared in related document groupings for automated grouping of the electronic image records under related tracking numbers. Users with different authorizations can access and retrieve particular documents using a computer over the Internet.

### CROSS-REFERENCE TO RELATED APPLICATIONS

This application claims priority from, and is a 35 U.S.C. § 111(a) continuation-in-part of, co-pending PCT international application serial number PCT/US2004/012301 filed on Apr. 21, 2004 which designates the U.S., incorporated herein by reference, and which in turn claims priority from U.S. provisional patent application Ser. No. 60/464,577 filed on Apr. 21, 2003, which is incorporated herein by reference in its entirety. Priority is claimed to each of the foregoing applications.

This application is also related to PCT International Publication No. WO 2004/095195 A2, published on Nov. 4, 2004, incorporated herein by reference in its entirety.

### STATEMENT REGARDING FEDERALLY SPONSORED RESEARCH OR DEVELOPMENT

Not Applicable

### REFERENCE TO A COMPUTER PROGRAM APPENDIX

Not Applicable

### NOTICE OF MATERIAL SUBJECT TO COPYRIGHT PROTECTION

All of the material in this patent document is subject to copyright protection under the copyright laws of the United States and of other countries. Portions of the material in this patent document are also subject to protection under the maskwork registration laws of the United States and of other countries. The owner of the copyright and maskwork rights has no objection to the facsimile reproduction by anyone of the patent document or the patent disclosure, as it appears in the United States Patent and Trademark Office file or records, but otherwise reserves all copyright and maskwork rights whatsoever.

### BACKGROUND OF THE INVENTION

1. Field of the Invention

This invention pertains generally to document management systems, and more particularly to systems for electronically managing imaged documents.

2. Description of the Background Art

Various forms of high-volume document intensive business and other enterprises exist. In these settings, a great deal of manpower and resources are required in order to manage this paperwork. While a wide number of electronic document imaging and management systems and methods have been previously described, none of them have yet to accommodate many of the needs of certain particular document-intensive systems.

This is often the case where one record or series of records needs to be related within a group of documents, yet those documents don't often all have formats that may be anticipated or controlled. For example, various attachments of paperwork may be desirably linked together within a database for management and retrieval in relation to a main document that is controllable by a document manager as a primary user. These attachments may take many different forms, unpredictable for a uniform system of electronic recognition or automated management. One particular example is in human resources, where an employee file may contain many main or attachment documents and an efficient document management system for controlled management and retrieval of them on a computer has yet to be made efficient and useful in many circumstances.

Another very special and dramatic situation where electronic document control of shipping records is very difficult to achieve predictably is the freight industry. In particular, when shipping freight, various documents are required in order to ensure the freight is properly shipped and delivered, and that the details are properly recorded. These documents can include such documents as delivery receipts and accounting copies. In order to properly track the shipment of freight, the accompanying freight shipping documents must be stored and made available to verify pickup schedules, dates of receipt, etc. Many attachments to these documents are also often generated. Whereas a shipping company may provide controlled documents with Bill-of-Lading numbers pre-printed on them, the attachments can be generated from many different sources of many different forms.

With the advent of document scanners, it has become possible to scan the freight documents and electronically store them in a database. However, as the number of documents generated increases, it becomes increasingly difficult to manage the documents, i.e., store the documents with accompanying tracking numbers and make them available for retrieval.

The present invention recognizes and satisfies a need for a system and method for efficiently managing the numerous documents associated with many different document-intensive industries.

In particular, the present invention specifically provides a highly efficient and improved system and method for controlled management and retrieval of various documents related to the delivery of freight.

### BRIEF SUMMARY OF THE INVENTION

In one aspect of the present invention a method for managing scanned documents includes scanning plural documents. Predetermined zones within the scanned documents can then be electronically read. Moreover, text within the zones can be compared to a predetermined table of key words. Based on the comparison, the documents are stored in a database.

Preferably, the text within one or more of the zones is compared to predetermined database of tracking numbers and based on the comparison, it is determined whether a tracking number within the zone is valid. In a preferred embodiment, each document having an invalid tracking number is flagged. Moreover, each flagged document is displayed to a user. Then, the user can manually edit each flagged document in order to change each invalid tracking number to a valid tracking number.

In another aspect of the present invention, plural freight documents are scanned. A first predetermined zone within the freight document is electronically read and the text therein is compared to a predetermined table of key words. Based on the comparison, the freight document is stored as a “Main Document” or an “Attachment.” Each “Main Document” can then be classified as an “Accounting Copy” or a “Delivery Receipt.”

In yet another aspect of the present invention, a system for managing documents includes a manager computer having a scanner and a database connected thereto. The manager computer includes a computer program therein for classifying imaged freight documents. The computer program includes logic means for electronically reading a predetermined zone within a scanned document and logic means for comparing text within said zone to a predetermined table of key words. A record of the scanned document can then be recorded in a database based on the comparison.

Another aspect of the invention includes a method for managing electronic images of documents by: creating an electronic image of at least one document; electronically reading information within at least one predetermined zone within said image; comparing the information read within said zone against a predetermined database of reference information; and at least partially based on said comparison, recording a record of said image in a database.

One mode of this method includes: comparing the information read within said zone against a predetermined database of reference tracking numbers. At least partially based on said comparison, it is determined if the information read within said zone comprises a valid tracking number that matches a tracking number in the database.

According to one embodiment of this mode, each record of each image that is not determined to comprise a valid tracking number within the zone is flagged. In a further feature, each flagged record is displayed at least in part to a user, who can for example manually edit each flagged record so as to provide a valid tracking number.

Another aspect of the invention is a method for managing electronic images of freight documents, and includes: creating an electronic image of at least one freight document; electronically reading information within at least a first predetermined zone within said image; and comparing the information read within said first zone against a predetermined table of reference information. At least partially based on said comparison, a record of said image is recorded in a database as a “Main Document” or an “Attachment”.

One mode of this aspect further includes: electronically reading information within at least a second predetermined zone within said image; and comparing the information read within said second zone against a predetermined table of reference information. At least partially based on said comparison, the record is recorded in a database as either an “Accounting Copy” or a “Delivery Receipt.”

One further embodiment of this mode includes: electronically reading information within at least a third predetermined zone within said image; and comparing information within the third zone against a predetermined database of reference Bill-of-Lading numbers. At least partially based on said comparison, it is determined if the information read within the third zone comprises a valid Bill-of-Lading number that matches a reference Bill-of-Lading number. According to further features, each record of each image is flagged that is not determined to comprise a valid Bill-of-Lading number in the third zone, and each flagged record is displayed to a user in order to manually edit each flagged record so as to establish a valid Bill-of-Lading number that matches a reference Bill-of-Lading number.

Another aspect of the invention is a system for managing documents, and includes: at least one manager computer; at least one scanner connected to said manager computer in a manner adapted to create at least one electronic image of at least one scanned document; at least one database connected to said manager computer; and a computer program operable by said manager computer. The computer program is characterized as providing: means for electronically reading information within at least one predetermined zone within the image; means for comparing information within said zone against a predetermined table of reference information; and means for storing a record of said image in said database at least partially based on said comparison.

One mode of this aspect further provides the computer program with means for comparing information read within said zone against a predetermined database of reference tracking numbers; and means for determining if the information read within said zone comprises a valid tracking number that matches a reference tracking number at least partially based on said comparison. Further embodiments of this mode further provides the computer program with means for flagging each record of each image not determined to comprise a valid tracking number, means for displaying each said flagged record to a user, and means for allowing a user to manually edit each said flagged record so as to establish a valid tracking number.

Another aspect of the invention is a system for managing freight documents, and includes: at least one manager computer; at least one scanner connected to said manager computer in a manner adapted to create at least one electronic image of at least one freight document; at least one database connected to said manager computer; and a computer program within said manager computer. The computer program according to this aspect includes: means for electronically reading at least a first predetermined zone within the image; means for comparing information within said first zone to a predetermined table of reference information; and means for recording a record of said image in a database as a “Main Document” or an “Attachment” at least partially based on said comparison.

One further mode of this aspect provides the computer program further with: means for electronically reading information within at least a second predetermined zone within said image; means for comparing information within said second zone against a predetermined table of reference information; and means for recording a record of said image in a database as either an “Accounting Copy” or a “Delivery Receipt” at least partially based on said comparison.

One embodiment of this mode further adapts the computer program with means for electronically reading information within at least a third predetermined zone within said image; means for comparing the information read within said third zone against a predetermined database of Bill-of-Lading numbers; and means for determining if a Bill-of-Lading number within said third zone is valid at least partially based on said comparison. Further beneficial features of this embodiment may also include: means for flagging the record for said image having an invalid Bill-of-Lading number; means for displaying each record of each image with an invalid Bill-of-Lading number to a user; and means for allowing a user to manually edit each record of each image having an invalid Bill-of-Lading number to establish a valid Bill-of-Lading number for each record.

Another aspect of the invention includes a method for managing electronic images of documents, and includes: creating a plurality of unique electronic images from a plurality of unique respective documents, respectively, such that each electronic image is associated with one of the documents; electronically reading information within at least one predetermined zone within each said image; and comparing the information read within each said zone of each said image against a predetermined database of reference information. At least partially based on the comparison for each image, a plurality of records associated with the plurality of images, respectively, are recorded. Also at least partially based on the comparison for each image, multiple records are related to each other so as to create uniquely identifiable and electronically retrievable groups of multiple related records.

Another aspect of the invention includes a method for managing electronic images of freight documents, and includes: creating a batch of unique electronic images from a batch of unique respective freight documents, respectively, such that each electronic image is associated with one of the freight documents in the batch; electronically reading information within at least one predetermined zone within each said image; and comparing the information read within each said zone of each said image against a predetermined database of reference information. At least partially based on the comparison for each image, a batch of records associated with the batch of images, respectively, are recorded. Also at least partially based on the comparison for each image, multiple records are related to each other so as to create a plurality of uniquely identifiable and electronically retrievable groups of multiple related records within the batch. Still further, also at least partially based on the comparison for each image, each record of each image in the database is designated or labeled as a “Main Document” or an “Attachment”. This method is furthermore characterized in that at least one of the groups includes at least one Attachment related to at least one Main Document.

Another aspect of the invention is a method for creating a manageable database of electronic images, and includes reading information within at least one zone of each of a series of electronic images of a series of documents, respectively, wherein the plurality of documents comprises Main Documents and Attachments. Based at least in part upon the information read, it is determined whether each image in the series corresponds with a Main Document. A record of each image is recorded in a database as a Main Document record if the information read within the zone of the image matches with the reference information. A record of each image that is not determined to be a Main Document is recorded in the database as an Attachment. Further with respect to the database, each Attachment is related to the next closest previously recorded Main Document in the series in a manner adapted to provide a uniquely identifiable and retrievable group of at least one Main Document and at least one related Attachment.

Another aspect of the invention is a system for managing electronic documents, and includes a computer program operable by a computer and that is operable to provide: means for electronically reading information within at least one predetermined zone within an electronic image of a document; means for comparing information within said zone against a predetermined table of reference information; and means for storing a record of said image in a database at least partially based on said comparison.

Another aspect of the invention is a system for managing freight documents, and includes a computer program operable by a computer so as to provide: means for electronically reading information within at least a first predetermined zone within an electronic image of a document; means for comparing the information read within said first zone against a predetermined table of reference information; and means for recording a record of said image in a database as a “Main Document” or an “Attachment” at least partially based on said comparison.

Another aspect of the invention is an electronic document management system that includes a computer readable and manageable database comprising a plurality of unique records corresponding with a plurality of unique electronic images, respectively, of a plurality of unique documents, respectively. The plurality of records includes a plurality of main records corresponding with a plurality of “Main Document” images, respectively, and a plurality of attachment records corresponding with a plurality of “Attachment” images, respectively. Each of the attachment records is adapted to be related to at least one of the main records so as to form a uniquely identifiable and retrievable group of records comprising at least one Main Document image and at least one related Attachment image. Furthermore, each of the Main Document images comprises a zone with information that is not provided by each of the Attachments and that is adapted to be electronically read and compared against a database of reference information so as to determine whether such Main Document image should be recorded in the database as a main record.

Another aspect of the invention is a freight document management system, and includes a Bill-of-Lading package of documents comprising an Accounting Copy document and a related Delivery Receipt document, wherein the Accounting Copy and the Delivery Receipt documents are related at least in part by a Bill-of-Lading number. A first bar code is provided on the Accounting Copy document and providing electronically recognizable indicia of the Bill-of-Lading number and that the document is the Accounting Copy. A second bar code is provided on the Delivery Receipt document and providing electronically recognizable indicia of the Bill-of-Lading number and that the document is a Delivery Receipt.

Another aspect of the invention is a freight document management system that includes a Bill-of-Lading package of documents comprising an Accounting Copy document and a related Delivery Receipt document, wherein the Accounting Copy and the Delivery Receipt documents are related at least in part by a Bill-of-Lading number. A first electronically recognizable indicator is located on the Accounting copy and indicates the Bill-of-Lading number and that the document is the Accounting Copy. A second electronically recognizable indicator is located on the Delivery Receipt document and indicates the Bill-of-Lading number and that the document is a Delivery Receipt. A reading system is also provided and is adapted to electronically read electronic images of documents in a manner such that the first or second indicators may be read and compared against a database of reference information in order to determine whether a document is an Accounting Copy document or a Delivery Receipt document.

Another aspect of the invention is a document image management computer program, and includes a set of instructions stored on a media accessible by a computer and executable on said computer. By executing at least a portion of said instructions on the computer, the computer is enabled to perform the following steps: electronically reading information within at least one predetermined zone within an electronic image of at least one document; comparing the information read within said zone against a predetermined database of reference information; and, at least partially based on said comparison, recording a record of said image in a database.

Another aspect of the invention is a freight document image management computer program that includes a set of instructions stored on a media accessible by a computer and executable on said computer. By executing at least a portion of said instructions, the computer is enabled to perform the following steps: electronically reading information within at least a first predetermined zone within an electronic image of at least one freight document; comparing the information read within said first zone against a predetermined table of reference information; and at least partially based on said comparison, recording a record of said image in a database as a “Main Document” or an “Attachment”.

Another aspect of the invention is a document image management system that includes a computer and programming executable by the computer. At least a portion of the programming carries out the following operations: electronically reading information within at least one predetermined zone within an electronic image of at least one document; comparing the information read within said zone against a predetermined database of reference information; and at least partially based on said comparison, recording a record of said image in a database.

Another aspect of the invention is a freight document image management system that includes a computer and programming executable by said computer. At least a portion of said programming carries out the following operations: creating an electronic image of at least one freight document; electronically reading information within at least a first predetermined zone within said image; comparing the information read within said first zone against a predetermined table of reference information; and at least partially based on said comparison, recording a record of said image in a database as a “Main Document” or an “Attachment.

Another aspect of the invention is a system for managing documents that includes a computer, electronic storage associated with said computer; and a computer program executable by said computer. At least a portion of the computer program carries out the following operations: electronically reading information within at least one predetermined zone of an electronic image; comparing information within said zone against a predetermined table of reference information; and storing said image or a record of said image in said electronic storage at least partially based on said comparison.

Another aspect of the invention is a system for managing freight documents, and includes a computer, electronic storage associated with said computer, and a computer program executable by said computer. At least a portion of said computer program carries out the following operations: electronically reading at least a first predetermined zone within an electronic image; comparing information within said first zone to a predetermined table of reference information; and recording said image or a record of said image in said electronic database as a “Main Document” or an “Attachment” at least partially based on said comparison.

According to various of the aspects described above, in further modes information read from imaged documents may include text, and the respective reference information comprises key words. In further embodiments of such modes, an optical character recognition computer program to read the text in a manner so as to compare the text against the key words.

In additional modes of the various aspects above, the information read and analyzed for document image record keeping and management includes a bar code.

In still further modes, one or more records of electronic images comprises a pointer that is adapted to allow for retrieval of an electronic file of the electronic image from a stored location, and/or may include an electronic file of the image itself.

It yet a further mode to these aspects, the following are also performed: allowing a first user with a first authorization to view only a first set of at least one image of a general set of multiple related images using a computer; allowing a second user with a second authorization to view a second set of at least one image of the general set using a computer; and wherein the second set comprises at least one document image that is not included in the first set. The first user may view only the first set using the Internet in one highly beneficial embodiment. According to further features of this embodiment, the following may also be performed: providing a web page accessible by the first user via the internet; in the web page, requiring an authorization code from the first user to be entered in order for the first user to view the first set; and whereby entering the authorization code, the first user is allowed to view only the first set.

In still another mode of the various aspects, at least one said electronic image comprises an image of a freight document.

In another highly beneficial mode, at least one said electronic image comprises an image of a human resources document.

In another highly beneficial mode, at least one said electronic image comprises an image of a freight document.

In another highly beneficial mode, at least one said electronic image comprises an image of a human resources document.

Each of the foregoing aspects, modes, embodiments, variations, and features is considered independently valuable either without requiring combination with the others; whereas such various combinations and sub-combinations apparent to one of ordinary skill are also considered still further valuable and beneficial independent aspects hereunder.

Further aspects of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings, which are for illustrative purposes only:

FIG. 1 is block diagram of one system for managing imaged documents.

FIG. 2 is flow chart of one operating logic flow according to one aspect of the present invention.

FIG. 3 is a flow chart of the imaging logic of the present invention.

FIG. 4A-B are exemplary related freight documents as “Accounting” and “Delivery Receipt” copies, respectively.

FIG. 5 is a flow chart of the shipment tracking logic of the present invention.

FIG. 6 is an exemplary “Home” page of the present invention.

FIG. 7 is an exemplary “Login” screen of the present invention.

FIG. 8 is an exemplary “Account Activity” screen of the present invention.

FIG. 9 is an exemplary “Account Status” screen of the present invention.

FIG. 10 is an exemplary “Freight pickup” screen of the present invention.

FIG. 11 is an exemplary “Contact” screen of the present invention.

FIG. 12 is an exemplary “Shipment Tracking” screen of the present invention.

FIG. 13 is a flow chart of the imaging management logic of the present invention.

FIG. 14 is an exemplary “Image Management Login” screen of the present invention.

FIG. 15 is an exemplary “Image Management” screen of the present invention.

FIG. 16 is an exemplary “Imaging Data Entry” screen of the present invention.

FIG. 17 is a second embodiment of an “Imaging Data Entry” screen of the present invention.

FIG. 18 is an exemplary “PRO Number Search” screen of the present invention.

FIG. 19 is an exemplary “PRO Number Search Results” screen.

FIG. 20 is an exemplary “Administrative Edit” screen of the present invention.

FIG. 21 is an exemplary “Administrative Edit Results” screen of the present invention.

FIG. 22 is an exemplary “PRO Number Edit” screen of the present invention.

FIG. 23 is an exemplary “PRO Number Edit Results” screen of the present invention.

FIG. 24 is an exemplary “Last 5 Entries” screen of the present invention.

FIG. 25 is an exemplary schematic representation of a series of imaged documents given particular designations as labels for inter-relating documents as groups within a batch.

FIG. 26A is an exemplary Accounting Copy of a freight document given a bar code in a particular zone for recognition by certain software operations provided herein.

FIG. 26B is an exemplary Delivery Receipt of a freight document related to the Accounting Copy document of FIG. 26A, and is provided with a bar code that shares some common information with the document of FIG. 26A, and has additional other information distinguishing it as a unique “type” of Main Document than that of FIG. 26A.

### DETAILED DESCRIPTION OF THE INVENTION

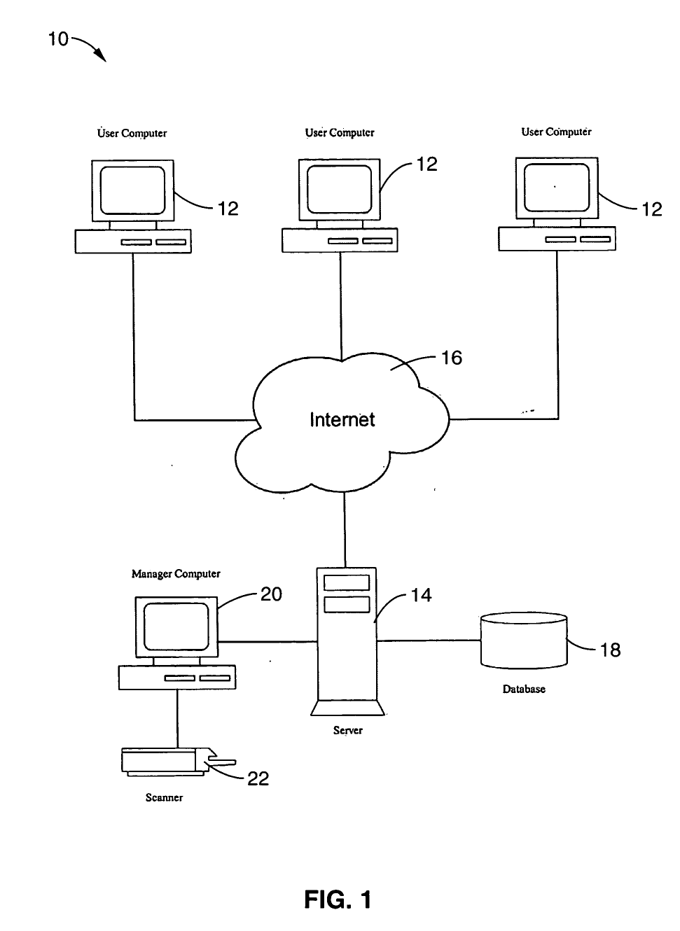

Referring more specifically to the drawings, for illustrative purposes the present invention is embodied in the apparatus and methods described with reference generally to FIG. 1 through FIG. 26B. It will be appreciated that the apparatus may vary as to configuration and as to details of the parts, and that the method may vary as to the specific steps and sequence, without departing from the basic concepts as disclosed herein.

Referring initially to FIG. 1, a system for managing imaged documents is shown and is generally designated 10. FIG. 1 shows that the system 10 includes plural user computers 12 connected to an image server 14 via the Internet 16. In turn, the image server 14 can be connected to an image database 18. Preferably, a manager computer 20 can be connected to the image server 14 and a scanner 22 can be connected to the manager computer 20.

As described in detail below, documents, e.g., freight documents, can be scanned with the scanner 22 and stored in the database 18. Plural users can access the scanned documents stored in the database 18 via the Internet 16 and the server 14. An administrator or manager can ensure the efficient and accurate operation of the system 10 through the user of the manager computer 20.

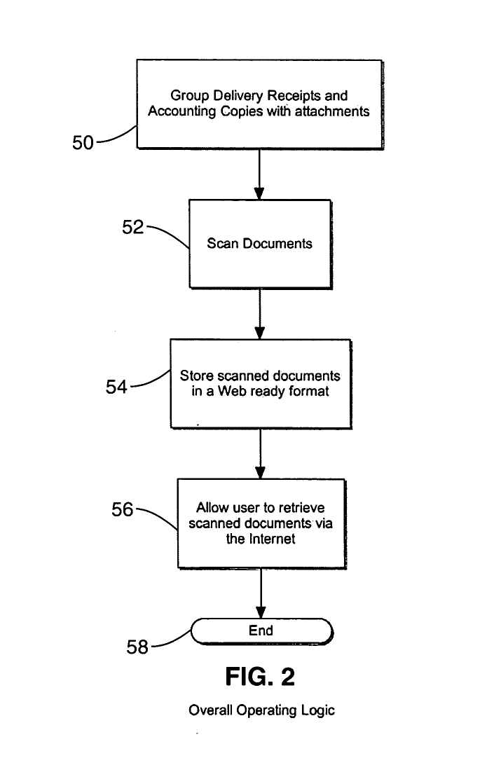

FIG. 2 shows the overall operating logic of the present illustrative embodiments of the invention. Commencing at block 50, delivery receipts and accounting copies are grouped with each other and include any applicable attachments. At block 52, all of the documents are scanned. Moving to block 54, the scanned documents are stored, e.g., in the database 18 (FIG. 1), in a Web ready format, e.g., HTML. At block 56, users are allowed to retrieve scanned documents from the database via the Internet. The overall operating logic ends at state 58.

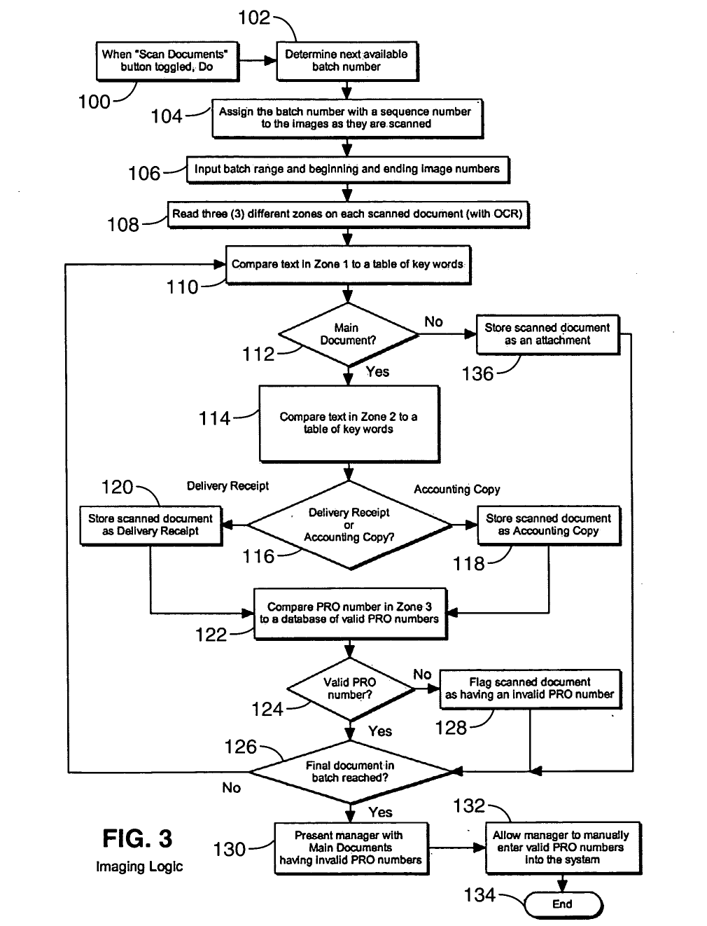

Referring now to FIG. 3, the imaging logic of one exemplary embodiment of the present invention is shown and begins at block 100 with a do loop wherein when a “Scan Documents” button is toggled, the succeeding steps are performed. At block 102, the next available batch number is determined. Next, at block 104, the batch number is assigned with a sequence number to the images as they are scanned. Proceeding to block 106, a batch range, a beginning image number, and an ending image number are input to the system, e.g., via the manager computer 20 (FIG. 1). At this point, processing of the imaged document converts the document to TIFF image format, followed by conversion to GIFF format for further retrieval, viewing, printing, emailing, and other use.

At block 108, three (3) different predetermined zones on each scanned document are preferably “read” using optical character recognition (OCR) software. Continuing to block 110, the text in Zone 1 is compared to a predetermined table of key words. At decision diamond 112, it is determined whether the scanned image is a “Main Document.” In a preferred embodiment, a “Main Document” is a “Delivery Receipt” or an “Accounting Copy.” If the scanned image is a “Main Document,’ the logic moves to block 114 where text in Zone 2 is compared to a predetermined table of key words. Based on the comparison, at decision diamond 116, it is determined whether the “Main Document” is a “Delivery Receipt” or an “Accounting Copy.”

If the “Main Document” is an “Accounting Copy,” the scanned document is stored as an “Accounting Copy” at block 118. On the other hand, if the “Main Document” is a “Delivery Receipt,” the scanned document is stored as a “Delivery Receipt” at block 120. From block 118 or block 120, the logic proceeds to block 122 where a Bill-of-Lading or “PRO” number in Zone 3 is compared to a database. It is to be understood that the PRO number is a tracking number assigned to each shipment and can be used to track the status of each shipment. Based on the comparison, at decision diamond 124, it is determined whether the PRO number is a valid PRO number. If so, the logic moves to decision diamond 126. Otherwise the logic moves to block 128, where the scanned document is flagged as having an invalid PRO number. The logic then proceeds to decision diamond 126.

At decision diamond 126 it is determined whether the final document in the batch is reached. If not, the logic returns to block 110 and continues as described above. If the final document has been reached, the logic proceeds to block 130 and a manager is presented with any “Main Documents” that were flagged as having invalid PRO numbers. Thereafter, at block 132, the manager is allowed to manually enter valid PRO numbers for each flagged document into the system. The logic then ends at state 134. Returning to decision diamond 112, if the scanned document is not a “Main Document,” the scanned document is stored as an attachment at block 136. The logic then proceeds to decision diamond 126 and continues as described above.

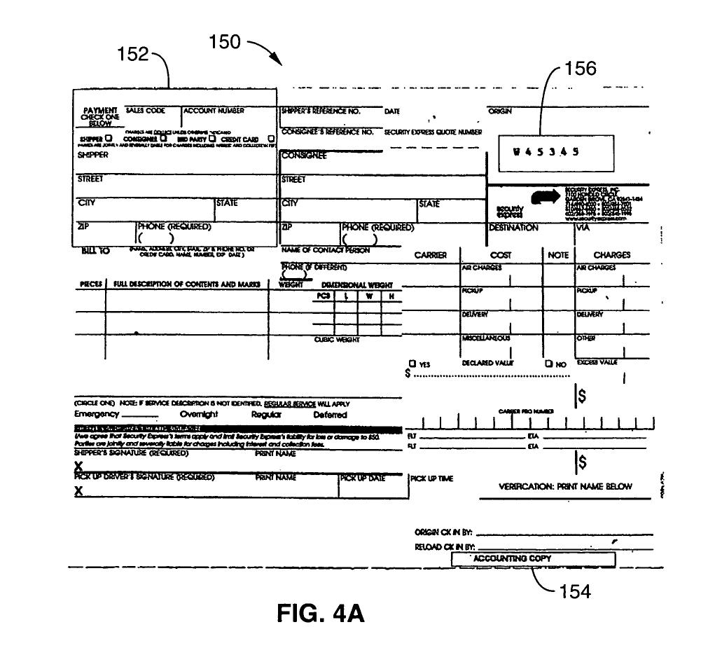

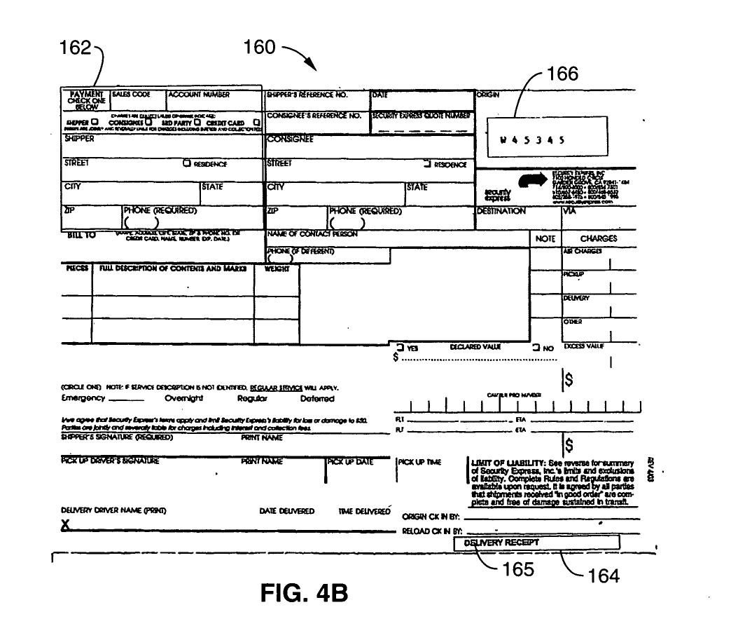

FIG. 4A shows a non-limiting, exemplary freight document, generally designated 150. As shown in FIG. 4A, the freight document 150 includes a first zone 152, a second zone 154, and a third zone 156. These zones are “read” as described above in order to classify the document as it is scanned and stored in the database 18 (FIG. 1). It is to be understood that the freight document 150 can include less or more than three zones as shown and the location of each zone can be changed depending on the needs of the system or particular application to specific documents or intended use. As shown in this particular embodiment, freight document 150 is determined to be an “Accounting Copy” as designated by the textual information within second zone 154.

FIG. 4B shows for further illustration an exemplary “Delivery Receipt” document 160 related to the Accounting Copy document 150 read and managed according to FIG. 4A. As shown, whereas first, second, and third zones 162, 164, and 166 are read in a manner similar to those similarly located zones in the FIG. 4A embodiment, the information 165 within zone 164 includes the text “Delivery Receipt” which is used to determine this status for the document.

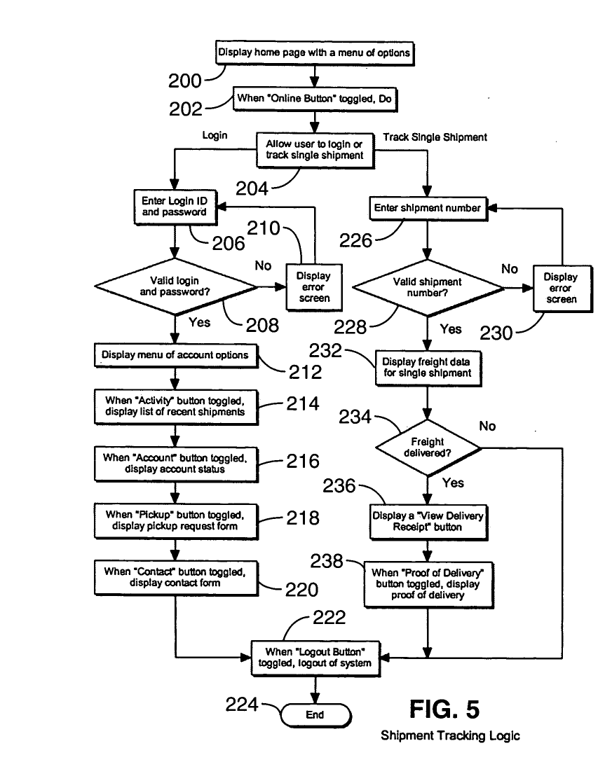

Referring to FIG. 5, the shipment tracking logic is shown and commences at block 200 where a “Home” page with a menu of options is displayed, e.g., at one of the user computers 12. Moving to block 202, when an “Online Button” is toggled, the following steps are performed. At block 204, a user is allowed to login to the system or track a single shipment. Proceeding to block 206, a user can enter a login identification (ID) and a password. At decision diamond 208, it is determined whether the login ID and the password are valid. If not, an “Error” screen is presented at block 210 and the logic returns to block 206 and continues as described above.

At decision diamond 208, if the login ID and password are valid, the logic continues to block 212 and a menu of account options is displayed to the user. At block 214, when an “Activity” button is toggled, a list of recent shipments and the status of each shipment is displayed. At block 216, when an “Account” button is toggled, a user's account status can be displayed.

Further, at block 218, when a “Pickup” button is toggled, a “Pickup Request” screen is displayed. Also, at block 220, when a “Contact” button is toggled, a “Contact” screen is displayed. Continuing to block 222, when a “Logout Button” is toggled, a user can be logged out of the system. The logic then ends at state 224.

Returning to block 204, a user can login to the system or track a single shipment. If the user chooses to track a single shipment, the logic moves to block 226 where a shipment number can be input to the system. Thereafter, at decision diamond 228, it is determined whether the shipment number is valid. If not, an “Error” screen is displayed at block 230 and the logic returns to block 226 where a user can re-enter a shipment. Otherwise, the logic moves to block 232 and freight data for a single shipment is displayed.

Moving to decision diamond 234, it is determined if the freight for that particular shipment has been delivered based upon a viewed image of a delivery receipt with receipt signature. If not, the logic proceeds to block 222 and continues as described above. If the delivery receipt has been recorded, a “View Delivery Receipt” button is displayed to the user at block 236. Continuing to block 238, when the “View Delivery Receipt” button is toggled, a delivery receipt is displayed to the user. The login then moves to block 222 and continues as described above.

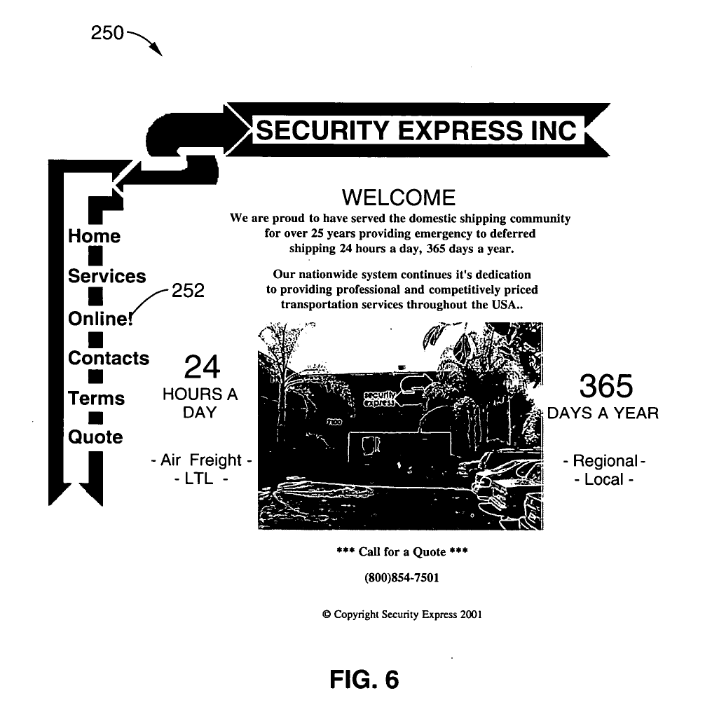

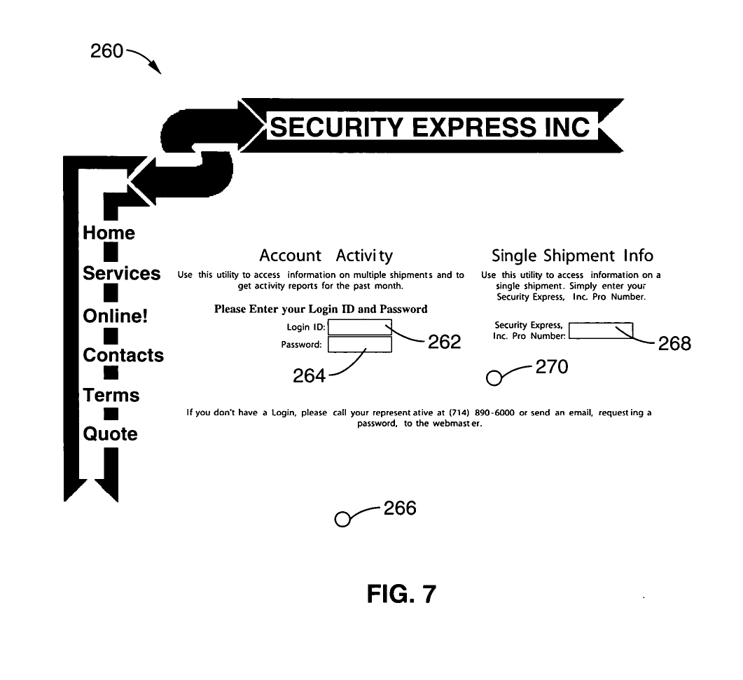

Referring now to FIG. 6, an exemplary, non-limiting “Home” screen is shown and is generally designated 250. FIG. 6 shows that the “Home” screen 250 includes an “Online” button 252 that can be toggled as described above, to open a “Login” screen shown in FIG. 7 and generally designated 260. FIG. 7 shows that the “Login” screen 260 includes a “Login ID” input field 262 in which a user can input a login ID, as described above. Moreover, the “Login” screen 260 includes a “Password” input field 264 in which a user can input a password, as described above. Once a user has input a login ID and password, a first “Go” button 266 can be toggled in order to login to the system. FIG. 7 also shows a “PRO number” input field 268 into which a user can input a “PRO number” in order to track a single shipment. Once the PRO number is input, the user can toggled a second “Go” button 270 in order to submit the PRO number to the system and retrieve shipping information linked to that particular PRO number.

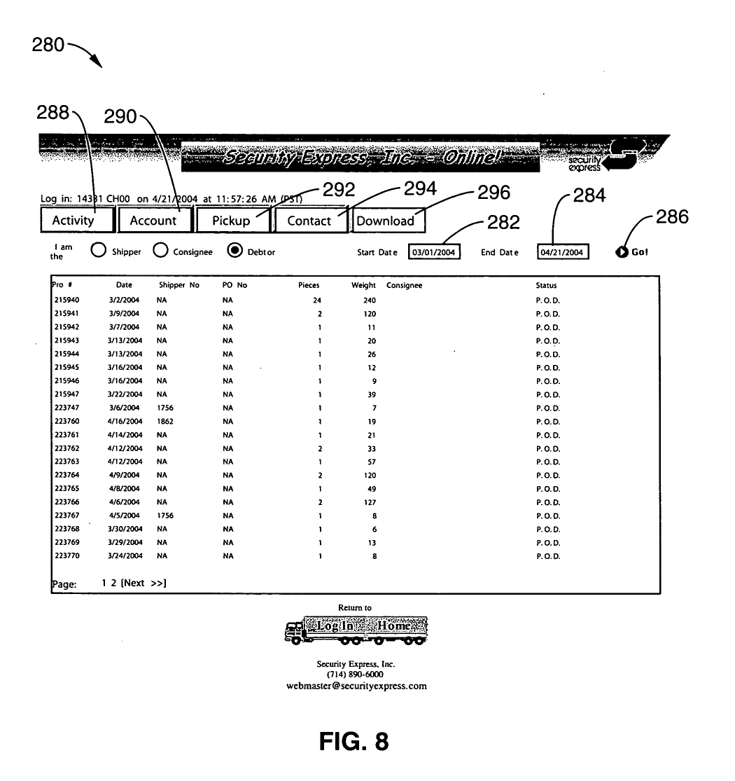

FIG. 8 shows an exemplary, non-limiting “Activity” screen, designated 280, that is displayed after a valid login ID and password are input to the system as described above. As shown, the “Activity” screen 280 displays a list of account activity, e.g., different shipments requested by the account holder. Moreover, the “Activity” screen 280 includes a “Start Date” input field 282 and an “End Date” input field 284. A user can enter a particular start date and a particular end date to the system in order to retrieve account activity within those dates. Preferably, a “Go” button 286 is displayed and can be toggled in order to input the start date and end date to the system. As shown in FIG. 8, the “Activity” screen 280 includes an “Activity” button 288, an “Account” button 290, a “Pickup” button 292, a “Contact” button 294,” and a “Download” button 296. These buttons can be toggled as described above to display the screens that correspond to each button.

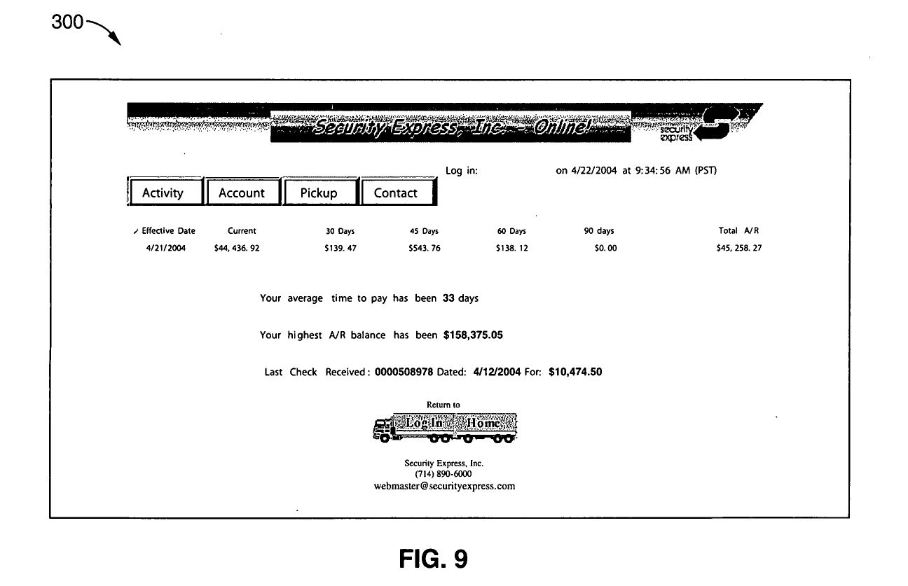

The following FIGS. 9-11 are herein shown and described for the purpose of further illustration to provide a complete understanding of one setting of other activities with which various aspects of the present invention may be viewed or processed.

FIG. 9 shows an exemplary, non-limiting “Account” screen designated 300. The “Account” screen can be displayed in response to the “Account” button 290 (FIG. 8) being toggled. As shown, the “Account” screen includes displays account information to the user. For example, the account information, can include “Effective Date,” “Current Due,” “30 days past due,” “45 days past due,” “60 days past due,” and “90 days past due.” Moreover, the “Account” screen 290 can include “average time to pay,” “highest A/R balance,” and “last check received” information.

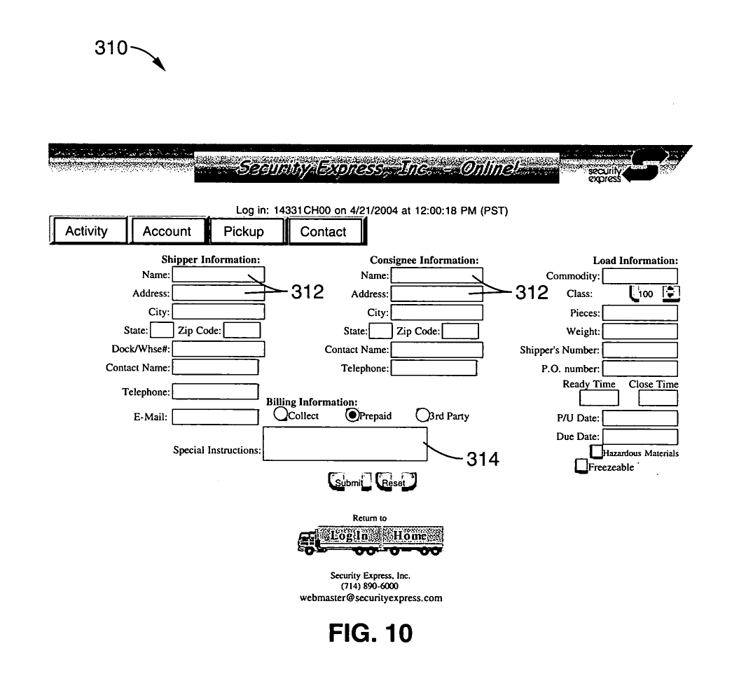

Referring to FIG. 10, an exemplary, non-limiting “Pickup” screen is shown and is generally designated 310. It is to be understood that the “Pickup” screen 310 can be displayed in response to the “Pickup” button 292 (FIG. 8) being toggled as described above. As shown in FIG. 10, the “Pickup” screen 310 includes plural input fields 312 that allow a user to enter data required for the shipment of one or more pieces of freight. The input fields 312, for example, can include name, address, etc., for the shipper and name, address, etc., for the recipient. Also, the input fields 312 can include information for the freight such as, number of pieces, weight, pickup date, due date, etc. Further, a “Special Instructions” input field 314 is included and can allow a user to input special instructions regarding the nature of the package and the manner in which it should be handled.

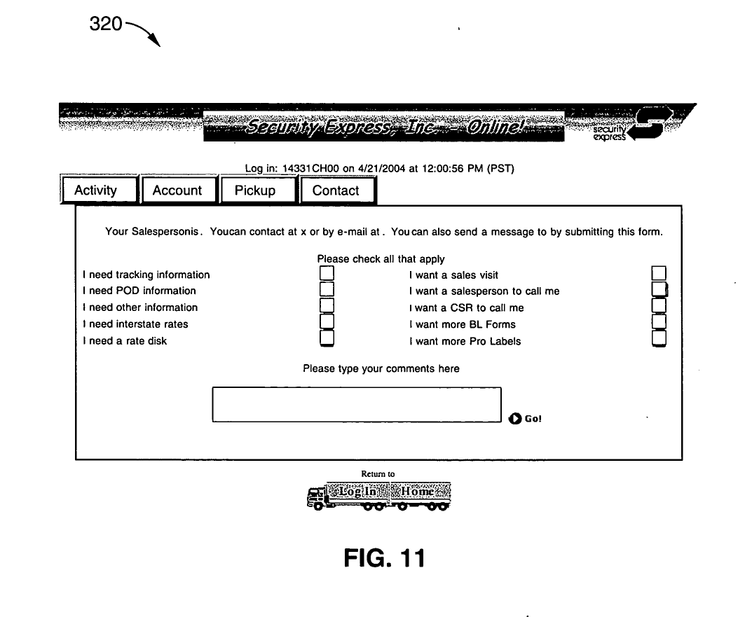

FIG. 11 shows an exemplary, non-limiting “Contact” screen, generally designated 320, that can be reached by toggling the “Contact” button 294 (FIG. 8) as described above. The “Contact” screen 320 can be used to contact the owner of the system in order to obtain information relevant to the shipment of goods.

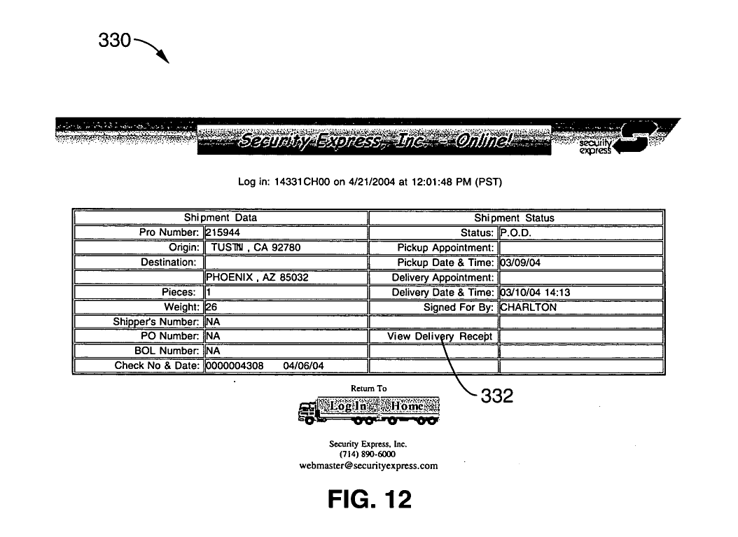

Referring now to FIG. 12, an exemplary, non-limiting single shipment tracking screen is shown and is generally designated 330. The single shipment-tracking screen 330 can be reached from the login screen 260 (FIG. 7) when a valid PRO number is input to the system as described above. FIG. 12 shows that the single shipment-tracking screen 330 includes information relevant to a particular shipment. That information, for example, can include PRO number, origin, destination, number of pieces, shipper's number, PO number, BOL number, check number and check date, status, pickup appointment, pickup date and time, delivery appointment, delivery date and time, and signed for by. As shown in FIG. 12, the single shipment-tracking screen 330 can include a “View Delivery Receipt” button 332. The “View Delivery Receipt” button 332 can be toggled, as described above, in order to display proof of delivery, e.g., a delivery receipt.

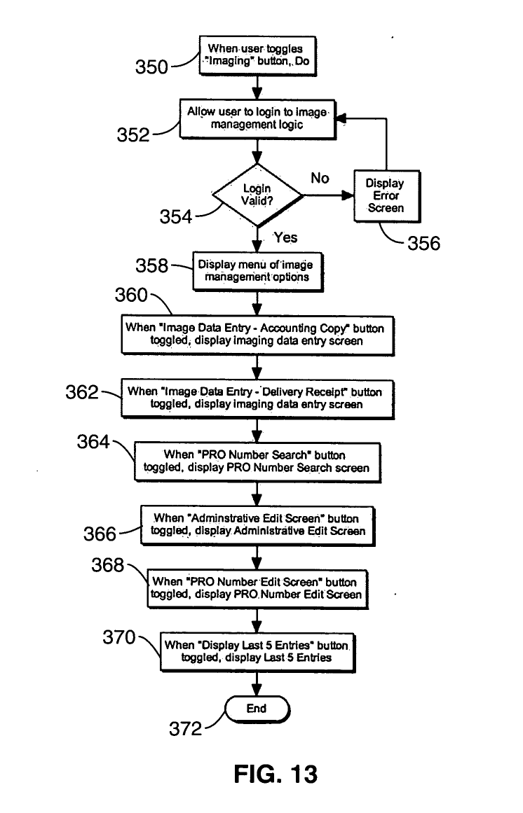

Referring now to FIG. 13, the image management logic is shown and commences at block 350 with a do loop wherein when a user, e.g., an administrator or manager, toggles an “Imaging” button, the following steps are performed. At block 352, the user is allowed to login to the image management portion of the system. Moving to block 354, it is determined whether the login is valid. If not, the logic moves to block 356 where an “Error” screen is displayed, and the logic returns to block 352 where a user can again attempt to login to the image management portion of the system. If the login is valid, the logic moves to block 358 where a menu of image management options is displayed to the user. At block 360, when an “Image Data Entry—Accounting Copy” button is toggled, an image data entry screen, described below, is displayed to the user. At block 362, when an “Image Data Entry—Delivery Receipt” button is toggled, an image data entry screen, described below, is displayed to the user. Moreover, at block 364 when a “PRO Number Search” button is toggled, a “PRO Number Search” screen, described below, is displayed to the user. Also, at block 366, when an “Administrative Edit Screen” button is toggled, an “Administrative Edit” screen, described below, is displayed to the user.

Continuing to block 368, when a “PRO Number Edit Screen” button is toggled, a “PRO Number Edit” screen is displayed to the user. Further, at block 370, when a “Display Last 5 Entries” button is toggled, a “Last 5 Entries” screen, shown below, is displayed to the user. The logic then ends at state 372.

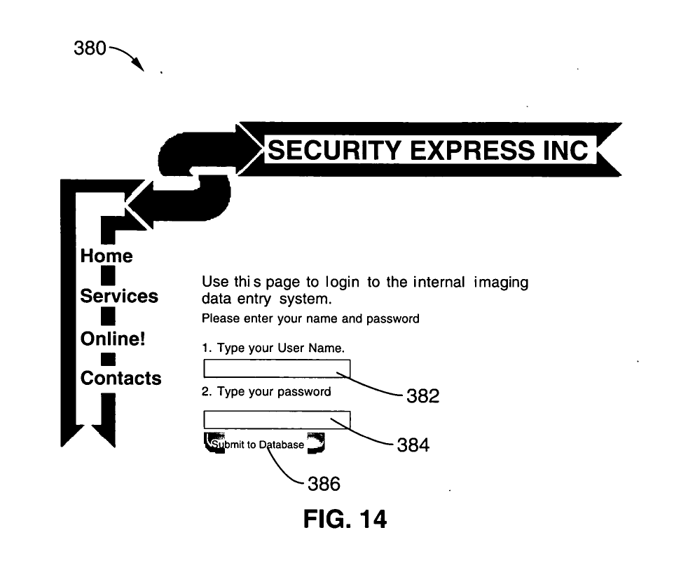

FIG. 14 shows an exemplary, non-limiting “Image Management Login” screen, generally designated 380. As shown, the “Image Management Login” screen 380 includes a “User Name” input field 382 and a “Password” input field 384. Once a user has input a user name and password to the respective input fields 382, 384, a submit button 386 can be toggled in order to submit the login information to the system where it is verified as described above.

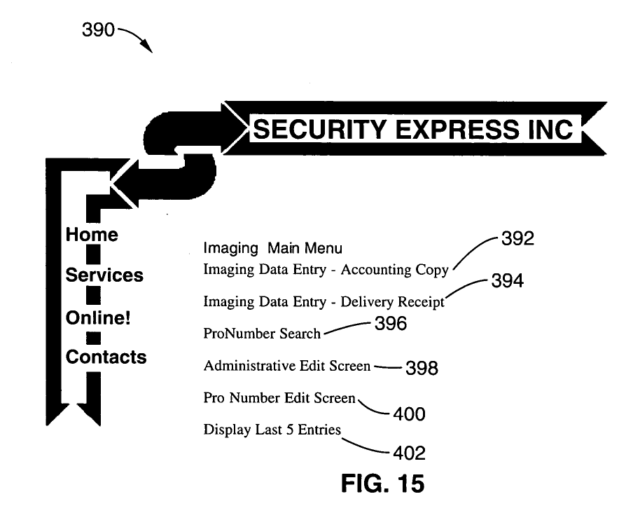

FIG. 15 shows an exemplary, non-limiting “Image Management” screen is shown and is generally designated 390. It is to be understood that the “Image Management” screen 390 can be displayed after valid login information is input to the system. As shown in FIG. 15, the “Image Management” screen 390 includes a menu of options that includes an “Imaging Data Entry—Accounting Copy” button 392, an “Imaging Data Entry—Delivery Receipt” button 394, a “PRO Number Search” button 396, an “Administrative Edit Screen” button 398, a “PRO Number Edit Screen” button 400 and a “Display Last 5 Entries” button 402. The buttons 392, 394, 396, 398, 400, 402 can be toggled as described above in order to navigate through the image management portion of the system.

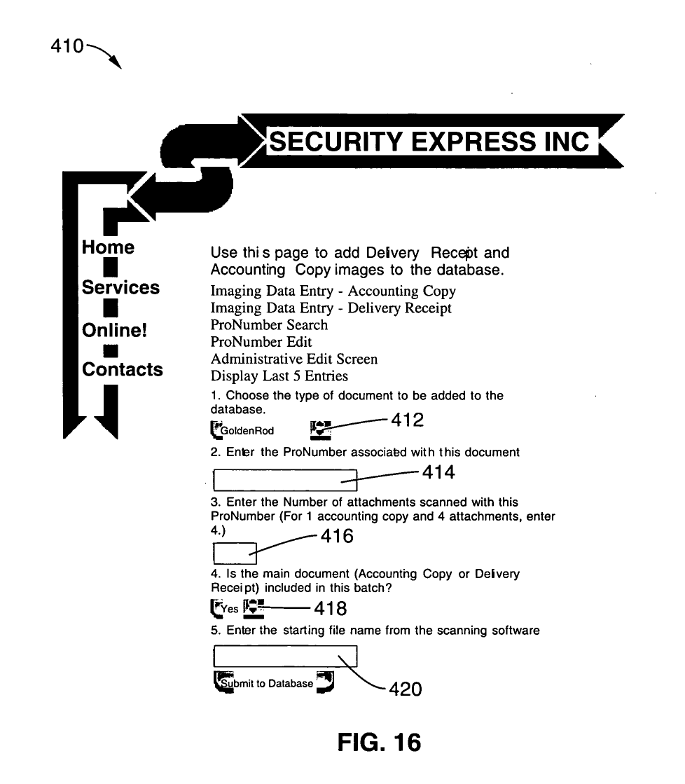

Referring to FIG. 16, an “Imaging Data Entry—Accounting Copy” screen is shown and is designated 410. FIG. 16 shows that the “Imaging Data Entry—Accounting Copy” screen 410 includes a type of document selection button 412 that can be used to select the type of document to be entered into the system. Moreover, the screen 410 includes a “PRO Number” input field 414 in which a PRO Number associated with the document to be entered into the system is input. Also, a “Number of Attachments” input field 416 is displayed and can be used to input the number of attachments associated with the PRO Number input to the “PRO Number” input field 414.

As shown in FIG. 16, the “Imaging Data Entry—Accounting Copy” screen 410 further includes an “Affirmative” button 418 that can be toggled if the main document, e.g., the accounting copy or delivery receipt, is include in the batch of documents to be entered into the system. Also, a “Starting File Name” input field is included 420 and a user can input the starting file name from the scanning software used in conjunction with the system. Further, the “Imaging Data Entry—Accounting Copy” screen 410 includes a “Submit” button 422 that can be toggled once the information is entered as described above.

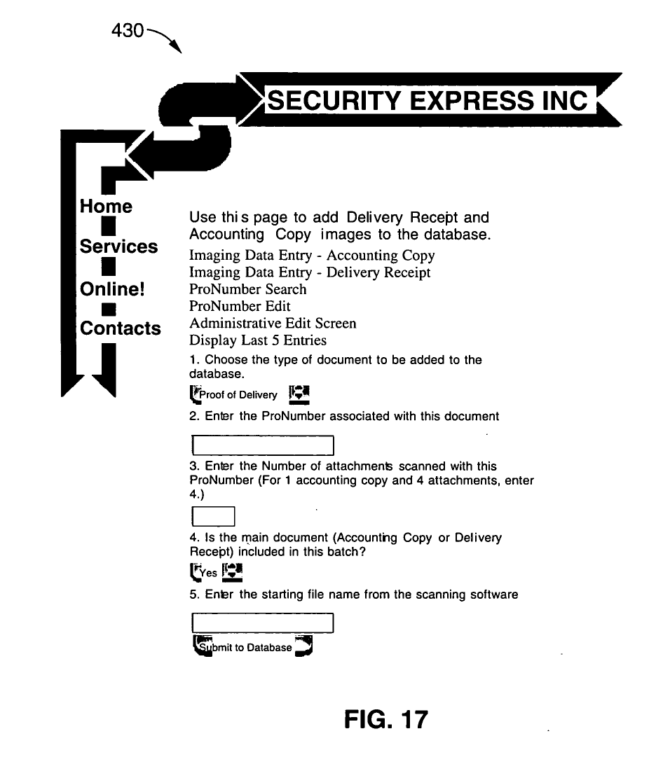

FIG. 17 shows an exemplary, non-limiting “Imaging Data Entry—Delivery Receipt” screen that is generally designated 430. The “Imaging Data Entry—Delivery Receipt” screen 430 can be reached by toggling the “Imaging Data Entry—Delivery Receipt” button 394 (FIG. 15). As shown in FIG. 17, “Imaging Data Entry—Delivery Receipt” screen 430 is essentially identical to the “Imaging Data Entry—Accounting Copy” screen 410 shown in FIG. 16.

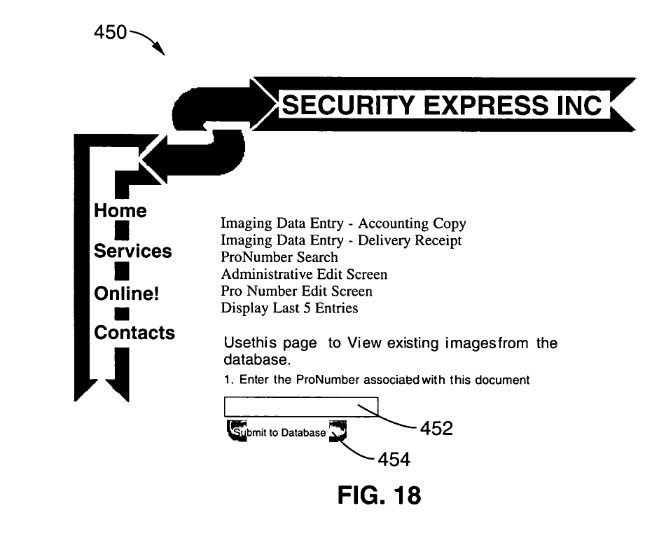

Referring now to FIG. 18, an exemplary, non-limiting “PRO Number Search” screen is shown and is generally designated 450. It is to be understood that the “PRO Number Search” screen 450 can be reached by toggling the “PRO Number Search” button 396 (FIG. 15). As shown in FIG. 18, the “PRO Number Search” screen 450 includes a “PRO Number” input field 452 into which a user can enter a PRO Number. The “PRO Number Search” screen 450 also includes a submit button 454 that can be toggled to input the PRO Number to the system after it is entered in the “PRO Number” input field 452.

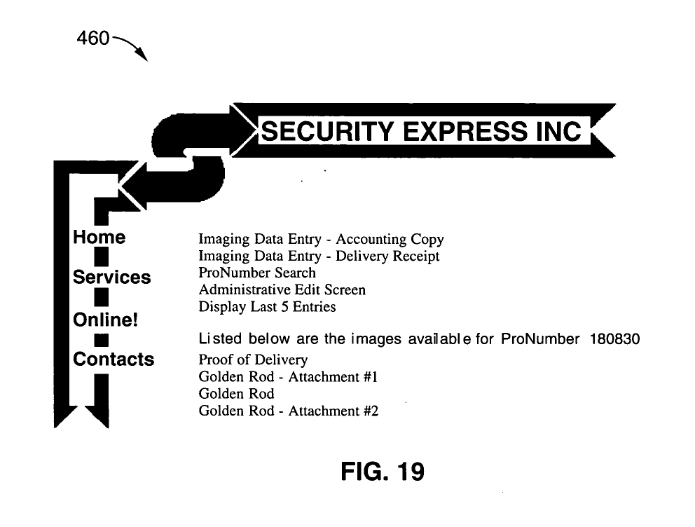

If a valid PRO Number is input to the system, a “PRO Number Search Results” screen is displayed to the user. FIG. 19 shows an exemplary, non-limiting “PRO Number Search Results” screen, generally designated 460. As shown, the “PRO Number Search Results” screen 460 includes a list of images available for a particular PRO Number that is input to the system as described above.

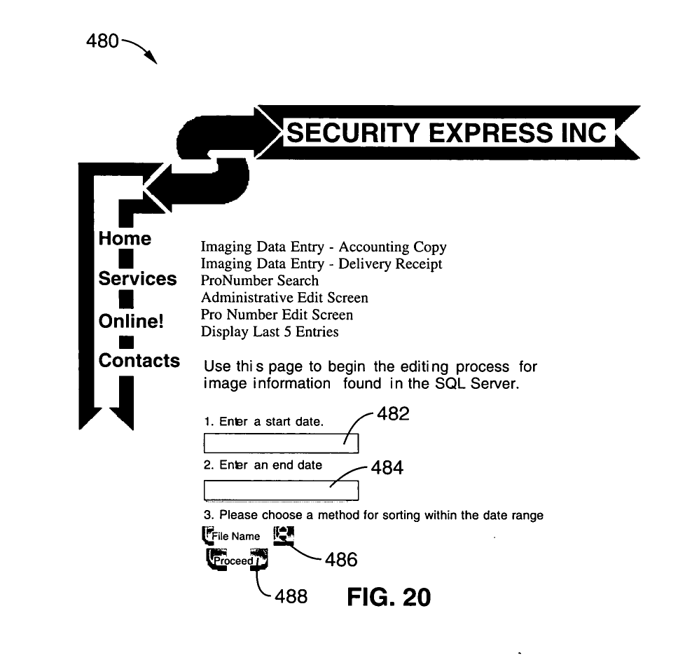

Referring to FIG. 20, an “Administrative Edit” screen is shown and is generally designated 480. It is to be understood that the “Administrative Edit” screen 480 can be reached by toggling the “Administrative Edit Screen” button 398 shown in FIG. 15. FIG. 20 shows that the “Administrative Edit” screen 480 includes a “Start Date” input field 482 and an “End Date” input field 484. As intended by the present invention, a user can input a start date and an end date and retrieve a list of imaged documents within that date range. As further shown in FIG. 20, the “Administrative Edit” screen 480 includes a “sort” button 486 that allows a user to choose how the documents within a date range are to be sorted. Also, the “Administrative Edit” screen 480 includes a “Proceed” button 488 that can be toggled to obtain a list of imaged documents within a date range input by the user.

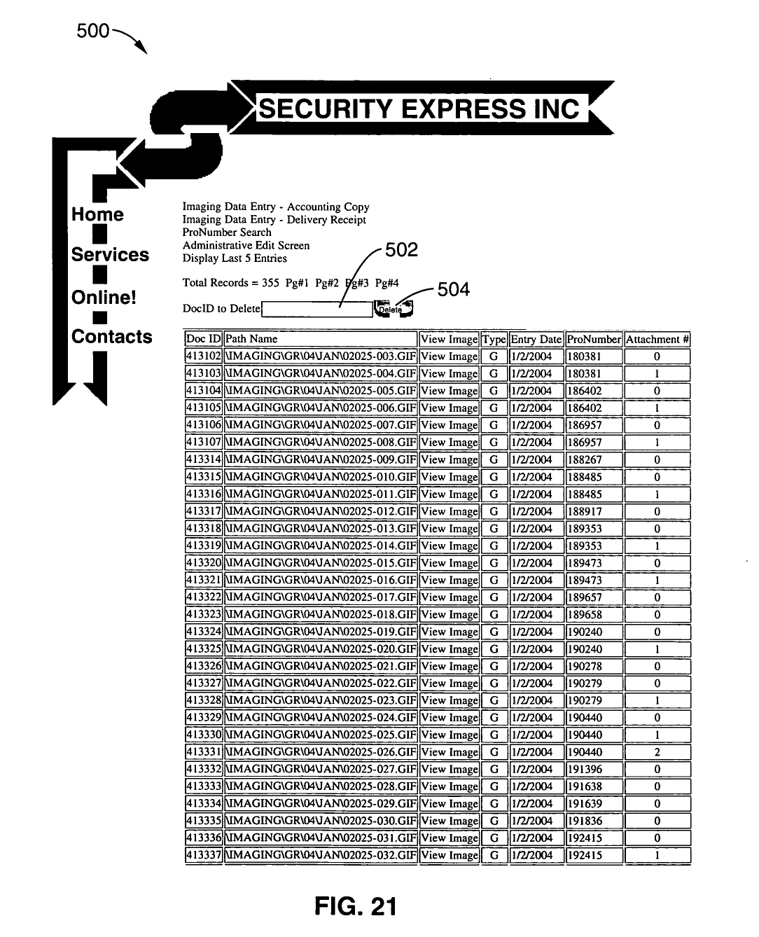

FIG. 21 shows an exemplary, non-limiting “Administrative Edit Results” screen, generally designated 500, that can be reached by toggling the “Proceed” button 488 (FIG. 20). As shown, the “Administrative Edit Results” screen 500 includes a list of imaged documents within a particular date range input to the system as described above. Moreover, the “Administrative Edit Results” screen 500 includes a “DocID to Delete” input field 502 in which a user can enter a document identification (DocID) number corresponding to a document that needs to be deleted. Once the DocID is input to the “DocID to Delete” input field 502, the user can toggle a “Delete” button 504 in order to delete the image corresponding to the DocID input by the user.

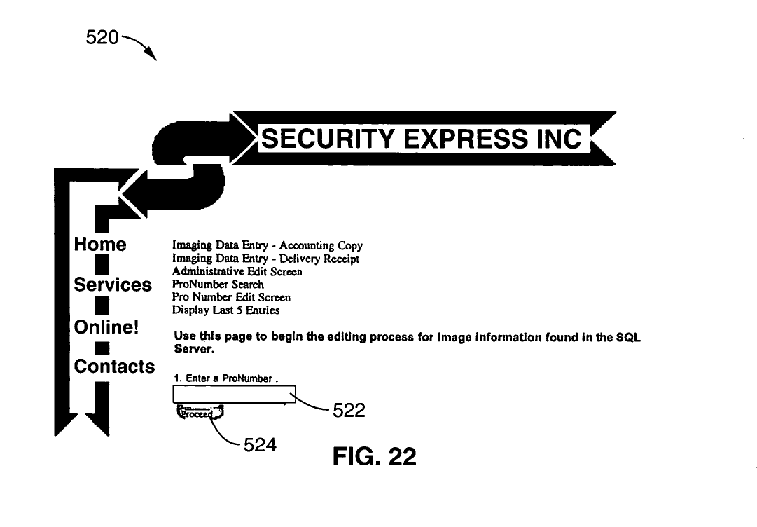

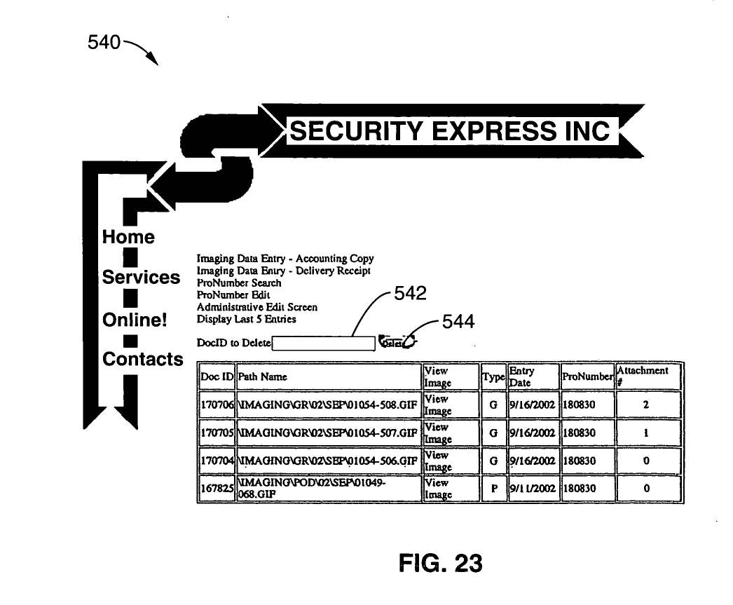

Referring to FIG. 22, an exemplary, non-limiting “PRO Number Edit” screen is shown and is generally designated 520. The “PRO Number Edit” screen 520 can be reached by toggling the “PRO Number Edit Screen” 400 (FIG. 15). As shown, the “PRO Number Edit” screen 520 includes a “PRO Number” input field 522 in which a user can input a particular PRO Number. Moreover, the “PRO Number Edit” screen 520 includes a “Proceed” button 524 that can be toggled to submit the PRO Number to the system. Once the system receives the PRO Number, it displays a “PRO Number Edit Results” screen shown in FIG. 23 and generally designated 540.

As shown in FIG. 23, the “PRO Number Edit Results” screen 540 includes a list of documents linked to a particular PRO Number. Further, the “PRO Number Edit Results” screen 540 includes a “DocID to Delete” input field 542 and a “Delete” button 544. A user can enter a DocID into the “DocID to Delete” input field 542 and toggle the “Delete” button 544 in order to delete an image displayed on the “PRO Number Edit Results” screen 540.

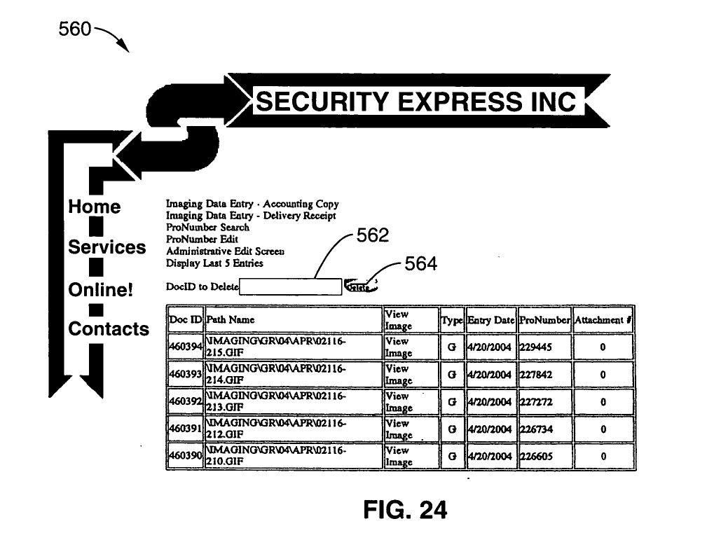

Referring now to FIG. 24, a “Display Last 5 Entries” results screen is shown and is generally designated 560. It can be appreciated that the “Display Last 5 Entries” results screen can be reached by toggling the “Display Last 5 Entries” button 402 shown in FIG. 15. As shown in FIG. 24, the “Display Last 5 Entries” results screen 560 includes a “DocID to delete” input field 562 and a “Delete” button 564. It can be appreciated that a user can enter a DocID into the “DocID to Delete” input field 562 and toggle the “Delete” button 564 in order to delete an image displayed at the “Display Last 5 Entries” results screen 560.

With the configuration of structure described above, the invention provides a means for effectively managing imaged freight documents so they can be easily and accurately retrieved from the system via the Internet.

While this is clearly one beneficial aspect of the invention, other independent beneficial aspects are also herein made clear.

In one particular regard, the present embodiments are illustrative of highly beneficial systems and methods for converting a series of documents into a manageable database. In one particular embodiment, such system and method beneficially allows for automated electronic gathering, recording, registering, and/or retrieving of independent related groupings of documents from a series of hard copy documents.

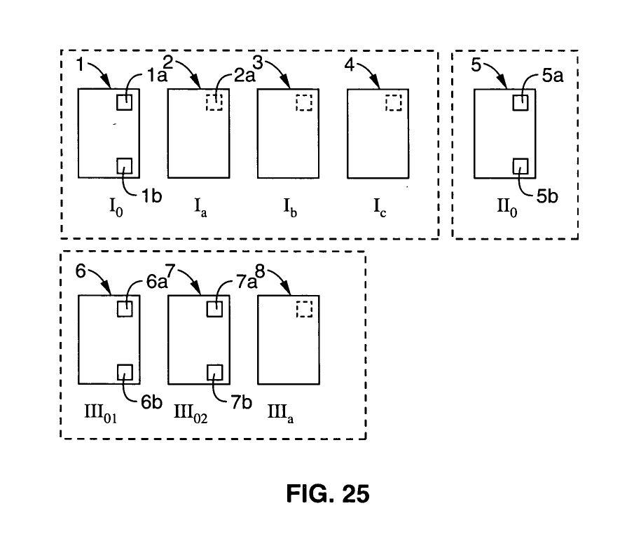

One particular illustrative example is shown in FIG. 25. In this embodiment, documents 1 through 8 are schematically shown as they are read in series through a scanner from a stack and recorded as electronic images. More specifically, they are stacked for scanning in series with document 1 first, document 2 second, and so on through n number of documents which may be unlimited (though a particular scanner input may limit the number documents that may be fed into a feeder in one physical stack). In the particular embodiment illustrated by this FIG. 25, main documents are provided for example with textual or bar code information in a first designated zone for optical character or bar code recognition, and a second zone provides information regarding what type of main document it is.

In any event, whether one stack or multiple stacks are used, typically documents according to present embodiments are entered in a “batch”. A batch may be created based upon a particular amount of documents created and requiring management over a particular period of time, such as a day's, week's, month's, quarter's, or other period's work completed by a particular user. Or, other factors may impact when and how a particular batch is created.

FIG. 25 illustrates the initial ten documents in a batch as follows, whereas references to “documents” in the batch generally refers to electronic images created of the documents, such as following scanning of the batch. Document 1 includes a first zone 1a that is read for information to indicate whether or not it is a “Main Document.” As designated by solid line box in the FIG. 25, such information is found in that particular document and compared against a database of reference information, and a match thus does designate document 1 as a Main Document I₀. In this particular embodiment as applied for example to freight documents, this information furthermore includes a tracking number to be given to the Main Document, such as Bill of Lading number.

Thereafter, a second zone 1b is read to determine what type of Main Document that document 1 is, also by looking for information and comparing it against reference information. In the case of a freight document management system for example, Main Document I₀ may be determined to be either an Accounting Copy or a Delivery Receipt based upon the second zone 1b information read and compared against the reference database. Document 1 is thereafter recorded as Main Document I₀ according to the designated type.

Thereafter, document 2 is then processed according to the document management system. First zone 2a of document 2 is read for information in a manner similar to that described above for first zone 1a of document 1. However, in this case, no reference information is found indicating that document 2 is a Main Document. Therefore, by not indicating in the record for document 2 that it is a Main Document, it is automatically designated as an attachment to the next closest preceding Main Document recorded. In the present case, document 2 is labeled in the record as an Attachment Iₐ to Main Document I₀. Similar results are achieved for documents 3 and 4 as further Attachments I_{b,c}, respectively, to Main Document I₀.

Following the analysis, labeling, and recording of document 4 as an attachment to Main Document I₀, document 5 is then read and analyzed for recording in the management system. However, in this case, first zone 5ₐ of document 5 is found to have information that matches against the reference information database and is thus recorded as another new Main Document II₀. Accordingly, a first group I is thus completed that includes Main Document I₀ and Attachments Ia-c corresponding to documents 1 and 2-4, respectively; a second group II is begun at document 5 as Main Document II₀. In the present case, no attachments to Main Document II₀ are found, as the next document in the series, document 6, is found to be another Main Document to begin the next grouping.

The circumstance of the next grouping III beginning with document 6 illustrates further variations of the present embodiment, wherein two Main Documents are found in the group. Here, document 6 is found to be a Main Document per review of information in first zone 6a, and of a particular first type of Main Document per review of information in second zone 6b. However, the next read document 7 is also found to be a Main Document, though related to the first main document and thus included into the same grouping of document 6. Here, document 7 is of a particular second type of Main Document. As such, document 6 is recorded as Main Document III₀₁, whereas document 7 is recorded as Main Document III₀₂, though in the same group III that is managed together as a group in the management system. Document 8 is found not to be a main document, and is thus recorded as an Attachment IIIₐ to Main Documents III₀₁ and III₀₂, respectively.

The circumstance of Group III may be further illustrated and managed according to certain present embodiments as follows. Main Document III₀₁ may be for example an Accounting Copy of a shipment, whereas Main Document III₀₂ may be for example a Delivery Receipt of a shipment. Such may be determined according to the present illustration by review of information provided in second zones 6_{b} and 7_{b} of those respective documents 6 and 7. They may, however, be related together in the system based upon the Bill-of-Lading number shared between them under one Bill-of-Lading package of documents. This may be found for example among the information provided in either or both of the first and second zones in the respective documents. The respective attachments are further related within the group as explained above, as shown by example for document 8 as Attachment IIIₐ.

Further to the particular illustrative case of group III, by designating Main Document III₀₂ as a Delivery Receipt type of document, it may be made available for review by particular user(s) having authorization to view only that document. Such may be for example, shippers, agents, receiving parties, etc., and may be viewed for example over the Internet via a web page (i.e. based upon for example entering the PRO or Bill-of-Lading number at a particular prompt, either with or without further required authorization codes or information for confidentiality purposes). However, Main Document III₀₂, and/or the various attachments, may be made unavailable to such user(s) and thus kept confidential, whereas other class of users with proper authorization may review such further detail of records associated with a shipment.

It is to be appreciated that the foregoing example(s) of FIG. 25 are illustrative of certain broad aspects of the present invention. While particular embodiments thus shown and described are considered highly beneficial, other modes may be used to accomplish various objectives. For example, the use of multiple zones in the documents for document categorization and recording may be accomplished in one general zone with more information provided within it. Or, further zones may be employed as noted above.

Moreover, various modes may be employed to indicate, read, and compare the information of the various zones for document categorization and recording. In one regard according to various of the embodiments above, the information may be textual, such as for example printed Bill-of-Lading number, “Accounting Copy”, or “Delivery Receipt” words. In this embodiment, optical character recognition software may be used to automatically recognize this textual information for comparison against a database.

Or, a manual interface following scanning the batch may be used to allow manual input of Main Document numbers such as Bill-of-Lading number to correspond with a particular document viewed on a computer monitor to be the Main Document. And, in this mode, whether it is a first or second type of Main Document, e.g. Accounting Copy or Delivery Receipt, may also be manually entered. In this mode, document images not receiving such input may be automatically designated as attachments per the methods and modes described above.

It is to be further appreciated that further embodiments are contemplated that allow for hybrid modes of operation for reading, labeling, and recording documents of particular types and within particular related document groupings. For example, at times OCR software may fail, such as for example when foreign matter, writings, tears, etc. may degrade the characters in the field or zone being read on a document. Accordingly, manual interface, oversight, review, or auditing of an OCR-based system of document management may allow for overriding or editing of the OCR-based results based upon visual review of the scanned and automatically categorized documents.

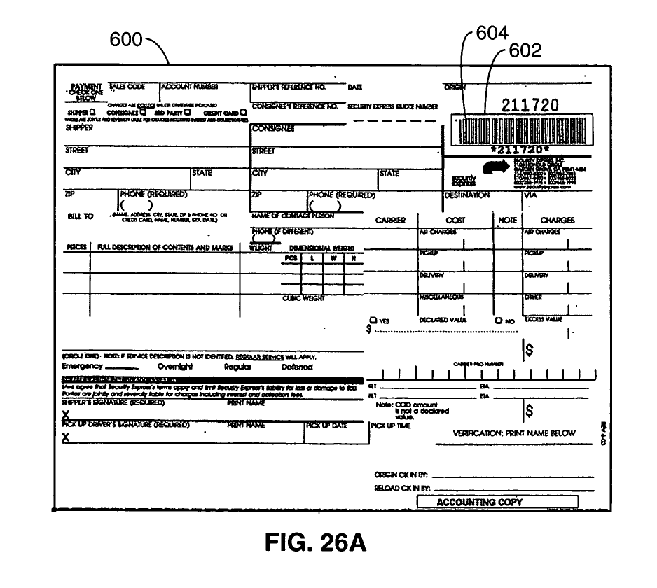

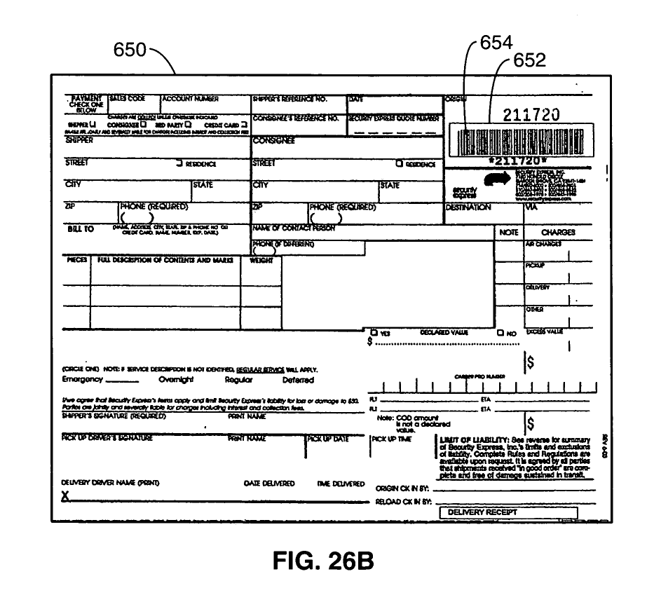

In still further embodiments, other techniques of providing and reading the requisite information for the desired document management may be used. In one particular highly beneficial embodiment, bar codes may be used. One example of a Bill-of-Lading document using such bar code label is shown in FIG. 26A. Here, document 600 is recognized as both an Accounting Copy type of Main Document related to a particular Bill-of-Lading number for a shipment based upon information found in bar code 604 located in zone 602. Software may be used to recognize this information based upon this bar code. It is to be appreciated however that bar code embodiments such as this may also be adapted for using a bar code reader prior to scanning the document, such that the respective information is entered in the record of the document at that time.

For further illustration, FIG. 26B shows a second main document 650 that also includes a bar code 654 in its read zone 652 indicating that it is also a second Main Document related to the same Bill-of-Lading shipment number as document 600. However, the further information in bar code 654 differs from bar code 604 such that this particular document 650 is designated as a Delivery Receipt rather than an Accounting Copy. Accordingly, with one bar code with certain shared and certain respectively unique information on each of these documents, they are automatically and appropriately grouped together and categorized in a way such that they may be distinguished in the way they are managed for later retrieval, viewing, or analysis.

It is also to be appreciated from the various foregoing embodiments that the records made and recorded of analyzed electronic images in one or more databases may take several different forms. The electronic images themselves as files may be a part of the record recorded, with other “label” information attached therewith that allows for software-based management of the images as content. Or, the records may include pointers, labels, addresses, etc., that are used in the database and management software for the various management operations, whereas the electronic image files themselves are stored in a separate location or file and may be located and retrieved based upon that record.

Various aspects of the invention are made clear according to the illustrative embodiments above, and are independently beneficial and valuable, whereas their various obvious combinations are further contemplated as additional beneficial and independent aspects.

For example, highly beneficial systems and methods are described that provides a document package of related individual documents to carry certain types of information in particular ways that allow for novel and beneficial electronic document image management systems and methods to be used. One particular beneficial example includes Bill-of-Lading packages with bar coded Main Documents as Accounting Copies or Delivery Receipts.

In another example, a system and method is provided that allows for manual preparation of a batch of documents that includes various groupings of unique and separate Main Documents in combination with their related attachments. By forming electronic scanned images of such a batch, further systems and methods provided allow for at least partially automated categorization of these documents into their respective groups so that they may be appropriately related within a database for document management.

In another example, groupings of related electronic document images are managed in a manner that allows for one class of users to retrieve and view certain particular documents of a type using a computer, and in further beneficial embodiments over the internet, whereas another particular class of users with different authorization or access may view another set of particular documents of the same group. Moreover, one class of the users may be allowed to perform certain operations based on or directly on the document retrieved and viewed, whereas another class of users may be either prevented from such operation or may be allowed a different operation.

The various automated and manual interface features provided hereunder are believed to substantially reduce the time and effort required to store, locate, and manage document records in a paper intensive field of endeavor. One particular highly beneficial field having particular unique document management requirements and needs is shipping. Accordingly, various specific examples provided hereunder are related to such shipping documents and their management, such as for example Bill-of-Lading documents and other related documents. These related other documents may be for example Bill-of-Lading documents of agents or other vendors, freight receipts, estimates and quotations, information regarding the shipment contents, reports, damage claims, payments, billings, other related shipments, etc.

Still further, other forms of documents and fields may be well served by the various aspects provided hereunder. For example, human resources documentation may become largely unwieldy to manage. In addition, certain documents may be beneficially made available to certain classes of people, such as employees or managers, whereas other documents may be more importantly left confidential for review and management by only certain other individuals, such as managers or human resources themselves. Documents containing information such as employment contracts, offers of employment, salary/pay information, annual or other forms of employee performance reviews, benefits information, etc., are examples of a package of documents that may relate to particular employees, plans, or HR packages that may benefit from the electronic document image management systems and methods herein shown and described.

The various aspects, modes, and embodiments of the present invention are well adapted for incorporation within the framework of many other networks, database tools and programs, and other document management systems. For example, various optical character recognition products may be employed to serve that function for reading and recognizing characters of imaged documents according to various illustrative embodiments herein described. One specific illustrative and non-limiting example for example is a product called “Vision Tools” that is available from Vision Shape, and may be customized for a particular application. According to another illustrative and non-limiting example, a product called “Sequel Server” available from Microsoft Corporation may be used for the purpose of the interactive database(s) herein described, and also may be modified or customized for a particular application or purpose consistent with this disclosure. Still further, with respect to specific applications, another illustrative and non-limiting example includes a product called “FreightDATA TRANSPORTATION SOFTWARE” which is available from Software Development Associates may be used in conjunction with the current embodiments for imaging, storing, and managing freight related documents.

The particular form of document images used and managed according to the various embodiments herein may also vary to meet a particular need, work with particular chosen software modules or retrieval, communication, or display formats. In one particular highly beneficial embodiment that is provided for illustration, when processing a batch of documents, they are converted from their native “tiff” format to a more universal “gif” format. Once in the gif format and submitted to the database, the scans can be easily viewed, saved, printed, or emailed via the network using most web-browsers.

Various particular details have been provided herein with respect to one particular illustrative embodiment providing a series of steps and screens for one mode of web-interface use and retrieval of managed electronic freight documents according to certain aspects of the present invention. However, it is to be appreciated that such detail is intended to be exemplary for a complete understanding of various modes of particular interactive use, but not intended to be limiting to the broad aspects of the invention herein described, such as for example in the claims and Summary of the Invention above. These various broad aspects are made apparent to one of ordinary skill in the art based upon a full review of this complete disclosure.

It is to be appreciated that reference to the term “system” as used herein is to be interpreted broadly, and may require and include only individual components apparatus, module, software sequence, device, etc. in that such may be useful for use and interfacing with other components in a broader system. In other words, the general aspects as objects of the invention need not be completely met by a component in order for it to still be considered beneficial in itself as a system adapted for use with other components or systems in a larger system framework.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

1-6. (canceled)

7. A method as recited in claim 24, further comprising:
electronically reading information within at least a second predetermined zone within at least one said image;
comparing the information read within said second zone against a predetermined table of reference information; and
at least partially based on said comparison, recording said record corresponding with the at least one said image in a database as either an accounting copy or a delivery receipt.

8. A method as recited in claim 7, further comprising:
electronically reading information within at least a third predetermined zone within said image;
comparing information within said third zone against a predetermined database of reference bill-of-lading numbers; and
at least partially based on said comparison, determining if the information read within said third zone comprises a valid bill-of-lading number that matches a reference bill-of-lading number.

9. A method as recited in claim 8, further comprising:
flagging each record of each image that is not determined to comprise a valid bill-of-lading number in the third zone.

10. A method as recited in claim 9, further comprising:
displaying each flagged record to a user.

11. A method as recited in claim 10, further comprising:
allowing a user to manually edit each flagged record so as to establish a valid bill-of-lading number that matches a reference Bill-of-Lading number.

12-17. (canceled)

18. A system as recited in claim 27, wherein said computer program further comprises:
means for electronically reading information within at least a second predetermined zone within said image;
means for comparing information within said second zone against a predetermined table of reference information; and
means for recording a record of said image in a database as either an accounting copy or a delivery receipt at least partially based on said comparison.

19. A system as recited in claim 18, wherein said computer program further comprises:
means for electronically reading information within at least a third predetermined zone within said image;
means for comparing the information read within said third zone against a predetermined database of bill-of-lading numbers; and
means for determining if a bill-of-lading number within said third zone is valid at least partially based on said comparison.

20. A system as recited in claim 19, wherein said computer program further comprises:
means for flagging the record for said image having an invalid bill-of-lading number.

21. A system as recited in claim 20, wherein said computer program further comprises:
means for displaying each record of each image with an invalid bill-of-lading number to a user.

22. A system as recited in claim 21, wherein said computer program further comprises:
means for allowing a user to manually edit each record of each image having an invalid bill-of-lading number to establish a valid bill-of-lading number for each record.

23. (canceled)

24. A method for managing electronic images of freight documents, comprising:
creating a batch of unique electronic images from a batch of unique respective freight documents, respectively, such that each electronic image is associated with one of the freight documents in the batch;
electronically reading information within at least one predetermined zone within each said image;
comparing the information read within each said zone of each said image against a predetermined database of reference information;
at least partially based on said comparison for each said image, recording a batch of records associated with the batch of images, respectively;
at least partially based on said comparison for each said image, relating multiple records to each other so as to create a plurality of uniquely identifiable and electronically retrievable groups of multiple related records within the batch;
at least partially based on said comparison for each said image, designating each record of each image in the database as a main document or an attachment; and
wherein at least one of said groups comprises at least one attachment related to at least one main document.

25-26. (canceled)

27. A system for managing freight documents, comprising:
a computer program operable by a computer, said computer program comprising:
means for electronically reading information within at least a first predetermined zone within an electronic image of a freight document;
means for comparing the information read within said first zone against a predetermined table of reference information; and
means for recording a record of said image in a database as a main document or an attachment at least partially based on said comparison.

28. (canceled)

29. The system of claim 30, further comprising:
a first bar code provided on the accounting copy document and providing the electronically recognizable indicator of the bill-of-lading number and that the document is the accounting copy; and
a second bar code provided on the delivery receipt document and providing the electronically recognizable indicator of the bill-of-lading number and that the document is a delivery receipt.

30. A freight document management system, comprising:
a bill-of-lading package of documents comprising an accounting copy document and a related delivery receipt document, wherein the accounting copy and the delivery receipt documents are related at least in part by a bill-of-lading number;
a first electronically recognizable indicator located on the accounting copy indicating the bill-of-lading number and that the document is the accounting copy;
a second electronically recognizable indicator on the delivery receipt document and indicating the bill-of-lading number and that the document is a delivery receipt; and
a system that is adapted to electronically read electronic images of documents in a manner such that the first or second indicators may be read and compared against a database of reference information in order to determine whether a document is an accounting copy document or a delivery receipt document.

31-35. (canceled)

36. The system of claim 27, wherein the computer program further comprises:
a set of instructions stored on a media accessible by a computer and executable on said computer;
wherein executing at least a portion of said instructions enables said computer to perform the steps comprising:
electronically reading information within at least a first predetermined zone within an electronic image of at least one freight document;
comparing the information read within said first zone against a predetermined table of reference information; and
at least partially based on said comparison, recording a record of said image in a database as a main document or an attachment.

37-47. (canceled)

48. A system as recited in claim 30, at least one said image further comprises:
a second predetermined zone within said at least one image
and that includes information that is electronically readable and identifies the at least one said image as either an accounting copy or a delivery receipt.

49. A system as recited in claim 48, wherein said at least one said image further comprises:
a third predetermined zone within said at least one image and that includes information that is electronically readable and identifying a bill-of-lading number associated with the at least one image.

50-63. (canceled)

64. The method of claim 24, wherein:
said information comprises text; and
said reference information comprises key words.

65. The method of claim 64, further comprising using an optical character recognition computer program to read the text in a manner so as to compare the text against the key words.

66. The method of claim 24, wherein:
said information comprises a bar code.

67. (canceled)

68. The method of claim 24, wherein at least one said record comprises a pointer that is adapted to allow for retrieval of an electronic file of the electronic image from a stored location.

69. (canceled)

70. The method of claim 24, further comprising:
allowing a first user with a first authorization to view only a first set of at least one image of a general set of multiple related images using a computer;
allowing a second user with a second authorization to view a second set of at least one image of the general set using a computer; and
wherein the second set comprises at least one document image that is not included in the first set.

71. The method of claim 70, further comprising allowing the first user to view only the first set using the Internet.

72. The method of claim 71, further comprising:
providing a web page accessible by the first user via the Internet;
in the web page, requiring an authorization code from the first user to be entered in order for the first user to view the first set; and
whereby entering the authorization code, the first user is allowed to view only the first set.

73-77. (canceled)
